(19) United States
(12) Patent Application Publication
(10) Pub. No.: US 2009/0316420 A1
(43) Pub. Date: Dec. 24, 2009

(54) Modified droplight with a pivotal clamp

(76) Inventor: Frank Villecco, Wantagh, NY (US)

Correspondence Address: Law Office;Richard B. Klar, Second Floor, 145 Willis Avenue, Mineola, NY, 11501, US

(21) Appl. No.: 12/214,678

(22) Filed: Jun. 20, 2008

(51) Int. Cl. F21V 21/08

(52) U.S. Cl. 362/396

(57) ABSTRACT

A droplight is modified by having a pivotal clamp mechanism attached to a reflector. This provides for a hands free droplight that can be utilized in a variety of ways that the standard droplight with a hook for suspension of the droplight cannot be used. It provides more lighting in different work environments and makes the light adjustable by a pivotal mechanism that can be adjusted up or down and sideways as well.

### BACKGROUND

1. Field

The present disclosure relates to a modified droplight. In particular, the present disclosure relates to a modified droplight with a pivotal clamp that is connected to the reflector portion of the droplight.

2. The Related Art

Conventional droplights each have a hook located at the top portion droplight to suspend or hang the droplight over the work environment and permit the worker to complete repairs in a hands-free manner. The problem with the use of a hook for securing the droplight in place is there are a number of work environments that are not conducive to a hook placement for securely placing the droplight. For example, if a plumber needs to work under a sink location there might not be a convenient place to affix the hook of the droplight for use. In addition, the hook of the droplight does not allow for easy adjustments and repositioning of the light for better illumination in the work environment.

It would be beneficial to use a mechanism and/or tool for use with any conventional droplight that provides a solution for these problems.

### SUMMARY

The present disclosure provides information on a droplight that is modified by having a pivotal clamp mechanism attached to a reflector. This provides for a hands-free droplight that can be utilized in a variety of ways. Therefore the standard droplight with a hook for suspension droplight cannot be used. It provides more lighting in different work environments and makes the light adjustable by use of a pivotal mechanism that can be adjusted in any direction the light is needed (for example, up, down, or sideways).

The present disclosure provides a modified droplight that permits a user to direct the light to the precise location as is needed. The present disclosure provides a modified droplight that expands the area of illumination by permitting more space to be covered without having to move the droplight from the location to which it is affixed.

In addition, the present disclosure provides a kit for modifying any existing conventional droplight so that it can provide more lighting for various kinds of work environments than was previously possible. This kit also provides for easy adjustments of the droplight in up, down and sideways adjustments for better illumination of the work environment as needed. The present disclosure provides modification of the reflector, thereby making it unnecessary to purchase an entirely new droplight, permitting existing droplights to be employed by replacing the reflector housing with the upgraded reflector housing of the present disclosure to provide for the droplight of the present disclosure.

The present disclosure provides a droplight clamp that can be folded away for later use.

### BRIEF DESCRIPTION OF THE DRAWINGS

FIG. 1 is a droplight with clamp attached to a vertical structure in accordance with the present disclosure;

FIG. 2 is a droplight with clamp attached to a horizontal structure in accordance with the present disclosure;

FIG. 3 is the droplight with clamp folded in accordance with the present disclosure;

FIG. 4 is another embodiment of the present disclosure in which the droplight reflector has a ball bearing that can be used as part of the pivotal mechanism for pivoting the droplight up, down and sideways.

FIG. (5) is section along lines (5)-(5) of FIG. 4; and

FIG. 6 is view along lines 6-6 of FIG. (5).

### DETAILED DESCRIPTION OF THE PREFERRED EMBODIMENTS

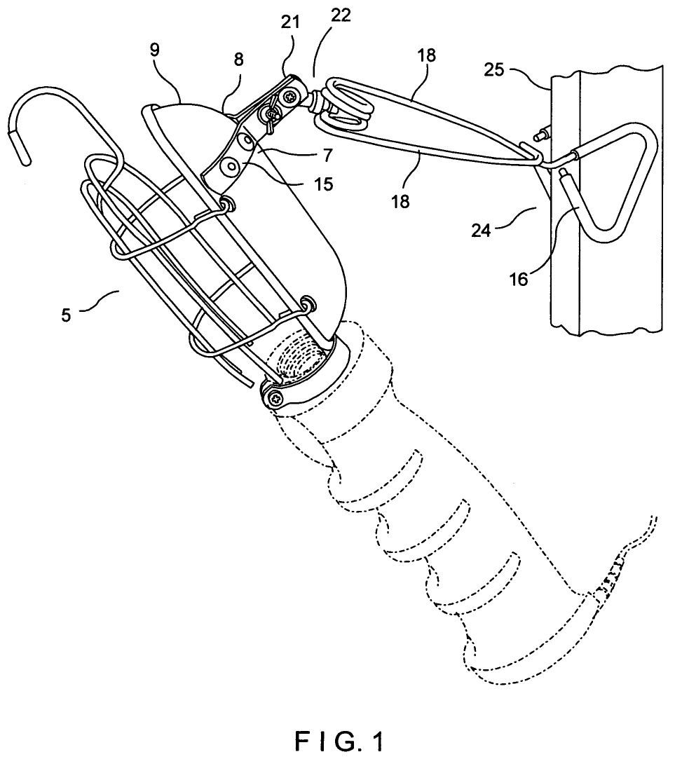

Referring to the drawings of FIGS. 1-6, FIG, 1 illustrates an embodiment of the present disclosure in which a droplight ((5)) has been modified for a clamp (6) to be affixed to a portion (8) of a reflector (7) of the droplight ((5)) by amounting bracket (4).

The reflector portion (8) to which the clamp (6) is affixed to with the mounting bracket (4) is mounted just below the area where the portion of the reflector curves radially inward (9) as seen in FIG. 1. The mounting bracket (4) includes a pair of strips (15), preferably metallic, connected to one end (19) of the clamp (6), preferably with screws and nuts. The strips have curved portions that curve around the reflector (9) and are screwed thereto or are otherwise affixed to the reflector's surface. The strips (15) have ends (21) that extend away from the reflector (9) and come together. The ends are screwed, or otherwise connected, to one another (see FIG. 1). These ends (21) are pivotally connected to a first end (22) of the clamp (6). A nut (10) can be placed in the middle between the ends (21) of the strips (15). The clamp has an end terminating where the two sides (18) meet. The two ends connect pivotally to the mounting bracket by a nut (10) located in between the ends (21), preferably at curved portions on each respective side of the two ends 21 (as shown in FIG. 5) of the strips (15) so as to pivotally attach the clamp (6) to the mounting bracket (4) (see FIG. (5)). This allows the clamp (6) to pivot with respect to the reflector (9) of the droplight, up or down, thus permitting the user to adjust the position of the droplight when the clamp is affixed to a structure, as shown in FIG. 1. The clamp can also pivot sideways if the wing nut in the bolt which passes through the nut is loosened permitting the nut to pivot sideways as shown (see FIG. 5) Alternatively instead of a nut (10), a ball bearing (10) can be used to permit the reflector (9) of the droplight (5) with the ball bearing being positioned between the ends (21), preferably at curved potions each on a respective side of the two ends 21 (as shown in FIG. 6) where the ball bearing (10) can be used to permit the reflector (9) of the droplight (5) and the clamp (6) to pivot with respect to one another not only up and down but also sideways (see FIG. 6). In this embodiment with the ball bearing (10) a bolt passes through the two ends (21) of the strips (15) above the ball bearing (10a) and the bolt is fastened in place by a wing nut or a nut as shown in FIG. 6. The clamp (6) is thus pivotally secured or connected to the mounting bracket (4) for the reflector (9).

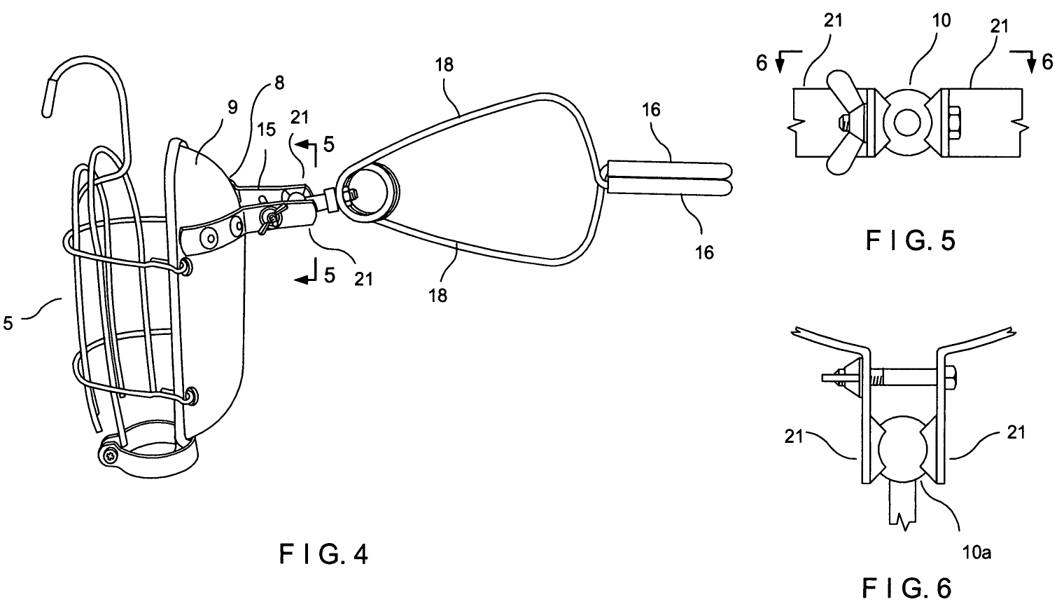

Portion 8 of the reflector (9) is connected to the mounting bracket (4) by the pair of strips (15) that can be screwed or otherwise affixed in place (see FIG. 4). Portion 8 is the portion just below where the reflector curves radially inward. It is preferable to affix portion 8 to the mounting bracket (4) to make the droplight (5) easier to carry and pivot and to provide for better illumination near a worker's face.

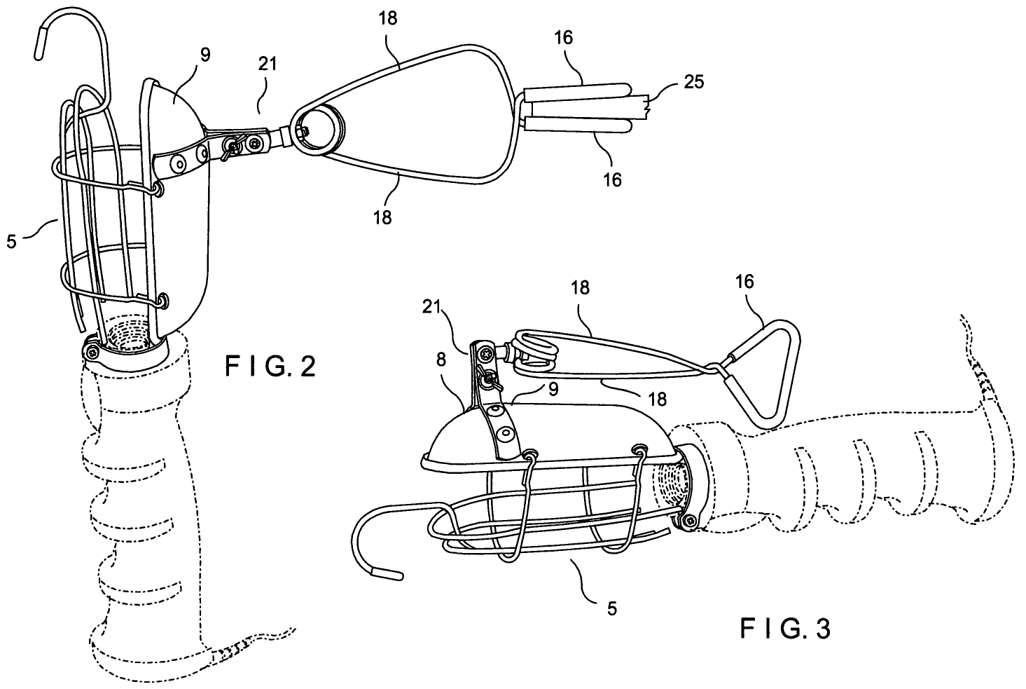

The clamp (6) has a pair of prong members or ends (16) at a second end (24) of the clamp (6) that are attached to a surface (25) to secure the droplight (5) in place and thus permit the droplight (5) to illuminate while permitting a worker to work hands free of the droplight (5). As shown in FIG. 1 the structure can be a vertical structure (25) or as shown in FIG. 2 it can be a horizontal structure (25). It is understood that the present disclosure is not limited to any particular structures.

The clamp (6) can alternatively have a spring (not shown) located between its two sides (18) as to add some tension to the clamping or the gripping action of the clamp (6).

The present disclosure provides for a kit for modifying the invention as described above where the kit includes the clamp 6, the reflector 9 and the mounting bracket formed of plates 1(5), and either or both nut 10 and ball bearing 10a with screws and nuts as required. The kit would be for replacing the reflector 9 with attached mounting bracket and clamp in place of the reflector of any convention droplight, In this way a worker can adjust and affix the droplight to for any intended work environment and have suitable lighting and a hands free environment for working with adequate lighting.

The embodiments described above are not meant to be exclusive. Many other variations of the present invention would be obvious to those skilled in the art, and are contemplated to be within the scope of the appended claims.

1. A modified droplight comprising:
a reflector having a radially inward curving portion;
a clamp having at one end a pair clamping ends adapted to grasp secure at least a portion of structure in between said pair of clamping ends; and
a pivotal mounting bracket adapted to pivotally connect another end of said clamp to the reflector near the radially inwardly curving portion of the reflector.

2. The modified droplight according to claim 1 wherein said pivotal mounting bracket includes a pair of curved metallic strips adapted to be fastened to the reflector just below the radially inward curving portion of the reflector, said pair of metallic strips being fastened together with a screw and nut where the nut is pivotal to pivot the mounting bracket and the reflector with respect to the clamp upward, downward or sideways thereby adjusting the position of the droplight accordingly.

3. The modified droplight according to claim 1 wherein said pivotal mounting bracket includes a pair curved metallic strips adapted to be fastened to the reflector just below the radially inwardly curving portion of the reflector that curves radially inward, said pair metallic strip having a ball bearing in between to pivot the mounting bracket and the reflector with respect to the clamp upward, downward or sideways thereby adjusting the position of the droplight accordingly

4. The modified droplight according to claim 1 wherein said clamp has structure formed of two sides connecting the pair of clamp ends to mounting bracket and said sides have a spring connected in between to increase the tension of the clamp.

5. A kit for modifying a droplight comprising:
a reflector having a radially inward curving portion;
a clamp having at one end a pair clamping ends adapted to grasp secure at least a portion of structure in between said pair of clamping ends; and
a pivotal mounting bracket adapted to pivotally connect another end of said clamp to the reflector near the radially inwardly curving portion of the reflector wherein said connected clamp, mounting bracket and reflector can be replace a reflector on a droplight to provide for a modified pivotally adjustable and clamp affixed modified droplight.

6. The kit according to claim 5 wherein said pivotal mounting bracket includes a pair curved metallic strips adapted to be fastened to the reflector just below the radially inwardly curving portion of the reflector, said pair of metallic strips being fastened together with a screw and nut where the nut is pivotal to pivot the mounting bracket and the reflector with respect to the clamp upward or downward or sideways thereby adjusting the position of the droplight accordingly.

7. The kit according to claim 5 wherein said pivotal mounting bracket includes a pair curved metallic strips adapted to be fastened to the reflector just below the radially inwardly curving portion of the reflector, said pair metallic strip having a ball bearing in between to pivot the mounting bracket and the reflector with respect to the clamp upward, downward or sideways thereby adjusting the position of the droplight accordingly

8. The kit according to claim 5 wherein said clamp has structure formed of two sides connecting the pair of clamp ends to mounting bracket and said sides have a spring connected in between to increase the tension of the clamp.

9. A method for modifying a droplight the steps comprising:
providing a reflector having a radially inward curving portion;
providing a clamp having at one end a pair clamping ends adapted to grasp secure at least a portion of structure in between said pair of clamping ends; and
pivotally connecting a pivotal mounting bracket to another end of said clamp to the reflector near the radially inwardly curving portion of the reflector; and
affixing said connected reflector, clamp and mounting bracket to a droplight to provide a pivotally adjustable clamp affixed modified droplight.
